(19) United States
(12) Patent Application Publication
(10) Pub. No.: US 2016/0288035 A1
(43) Pub. Date: Oct. 6, 2016

(54) THERMAL CENTRIFUGAL VANE TYPE SEPARATOR BAFFLE

(71) Applicant: NETAFIL INC., Toronto (CA)

(72) Inventor: Manuel Gomes Pereira, Toronto (CA)

(21) Appl. No.: 15/083,080

(22) Filed: Mar. 28, 2016

Related U.S. Application Data
(60) Provisional application No. 62/140,809, filed on Mar. 31, 2015.

(51) Int. Cl. B01D 45/08

(52) U.S. Cl. CPC B01D 45/08

(57) ABSTRACT

A gas purifier is disclosed for removing solid and liquid particles and to control humidity and volatile concentration in a gas stream. The device comprises of a plurality of vane-baffle elements. Each element comprising of a planar vane having a L-shaped cross section and a tubular baffle having a G-shaped cross section, wherein the baffle is attached to the vane forming a vane-baffle element. Each tubular baffle is annular allowing a secondary fluid to flow through it. A plurality of zig-zag shaped baffled partitioned are formed by attaching a plurality of vane-baffle elements to each other. A plurality of gas-stream passage ways are formed by vertically aligning said plurality of zig-zag partitions at a predefined partition spacing. A plurality of inlet manifolds are connected to the inlet ports to distribute a secondary fluid into each of said annular baffles, whereby the inlet temperature of said secondary fluid is controlled to control the temperature of the gas stream; and a plurality of outlet manifolds are connected to the outlet ports to collect the secondary fluid from each of the annular baffles.

### RELATED APPLICATION

This application is related to and claims the benefits of priority to the U.S. provisional application No. 62/140,809, filed on Mar. 31, 2015, and titled “Thermal Centrifugal Vane Type Separator Baffle”, and related to a U.S. Design Pat. No. 373,625, filed on May 19, 1995 and issued on Sep. 10, 1996, which is incorporated by references herein.

### FIELD OF THE INVENTION

The present invention relates generally to mist eliminators and wet scrubbers and particularly to baffle vane type separators.

### BACKGROUND OF THE INVENTION

Many industries produce gaseous products, which have to be purified before exhausting to the ambient. Such gaseous produces may contain solid particles and liquid droplets of a variety of sizes, which have to be separated from the gas stream before emission to the surroundings. Therefore, a wide variety of particle and mist separators are developed to purify such gas streams.

Many of the particle and mist separators are of a baffle-type or a vane-type separator. These separators change the direction of the gaseous flow in an attempt to force solid particles and liquid droplets to impact and collect on the surface of baffles located along the gas stream. These separators force the gas stream to change direction using chevron or zig-zag type of channels. Rapid change in the flow direction results in the impact of the particles on the surfaces. In order to make them work on very small particles extra pockets are added to the system to catch even smaller particles.

Baffle-type or vane type particle and mist eliminators are used in both vertical and horizontal gas flows. These separators are preferred over filter and bag houses because of their cost and low pressure drops. However, the currently available baffle-type particle and mist eliminators are only effective for larger particles and at high flow velocities.

These baffle or vane separators have numerous industrial applications, such as in separation of particles, aerosols, drops, and vapours of different volatile matters generated from bio-gas purification systems, cooling and humidity control systems, and from a variety of fume hoods, such as paint spray booths. Such devices are also used in purification of gas emissions from combustion devices, such as coal and oil burning boiler, burners, power plants, incinerators, and offshore oil/gas platforms. Offshore applications require that the weight of the equipment be as small as possible to decrease the transportation costs and increase the safety in extreme weather conditions. As a result, it is desirable to minimize the weight of such separators. Furthermore, it is desirable to use fewer components and less welding in the fabrication of these separators in order to decrease manufacturing costs.

### SUMMARY OF THE INVENTION

In accordance with the present invention, a new Thermal Centrifugal Vane Type

Separator Baffle (TCVTSB) is provided to remove particulates, liquids and vapours from a gas stream, such as those from pollution control systems (Wet-Scrubbers, Mist Eliminators, etc.). Vapours of various contaminants, such as SO2, CO and CO3, are removed by concentrating them in certain regions of the separator until their concentration reaches the saturation conditions. The saturated mater is then removed from the flow. Similarly, the humidity of a gaseous stream is reduced by saturating the vapour and removing condensed water from the humid stream.

The present separator comprises of a plurality of zig-zag plates (Vanes) aligned vertically and in parallel with each. Every two neighboring zig-zag plates form a tortious passage way for a gas stream. In order to separate particles, drops, and vapours from the gas stream, the gas is forced to go through a plurality of rotary path forcing the particles and drops to collect on the walls of the collector and to concentrate the vapours. In order to force the gas stream to go through a rotary path, a plurality of G-shape tubes (Baffles), referred to as G-traps, are vertically attached in between the gas stream passage ways. A G-shaped tube or a G-trap is basically a tube that about ¼ of its wall is removed allowing for gases to tangentially enter the tube. A small baffle is attached to one end of the removed wall forming a substantially G-shaped cross section. The small baffle forces the gases to recirculate inside the tube, preventing them to escape immediately after entering the tube. Therefore, a gas stream entering a G-trap goes through a rotational motion. The rotational motion result in centrifugal forces acting on particles and drops inside the gas stream, moving them towards the outer periphery of the tube and finally colliding them with the tube walls. The particles and drops then flow down on the walls of the tubes and are separated from the stream.

In addition, the G-shape tubes of the present device are annular, allowing for a secondary fluid to flow inside them. The temperature of the secondary fluid flowing through the G-shaped tubes is controlled to control the temperature of the gases trapped inside the G-traps. Therefore, when a vapour is trapped inside a G-trap, its concentration is increases by collecting more of the incoming vapour until its concentration reaches a saturation conditions. The saturation condition of each gas depends on its temperature. Therefore, the temperature of the vapour inside the G-traps is controlled using the temperature of the annular flow. Vapours of the materials to be removed are condensed and removed from the gas stream. In particular, humidity of the gas stream is controlled by condensing out the required percentage of the moisture from the stream.

The secondary fluid flowing through the G-shape tubes can also be used to recover thermal energy of a hot gas stream and control its exhaust temperature. The G-traps then behaves as heat exchanges, as well as gas purifiers.

The preferred method of making the zig-zag (Z-Z) plates of the present device is by using a strip of metal and bending a small part of it from one end by 90 degrees. Then, every two strip is welded together by overlapping the bent end one to the unbent end of the second one. This will form a zig-zag plate with 90 degree bend. Zig-zag plate with other angles can also be made using the same method. The length and width of each sheet is selected according to the size of the required gas purifier. A prefabricated G-shape tube is then attached to the vertex (the convex side) of each Z-Z plate.

One object of the present invention is to provide a gas purifier to reduce emissions and greenhouse air pollution, and to reduce the amount of carryover of mass and liquids.

Another object of the present invention is to provide a particle separator that does not plug. The presently available systems plug often and need to be cleaned to be efficient.

Another object of the present invention is to provide a separator with a higher removal efficiency that the prior art and having VOC, humidity control, tempering capability for the air/gas flow.

Another object of the present invention is to provide a gas purifier with heat recovery system to recover thermal energy of a hot gas stream.

Another object of the present invention is to control the temperature of a gas stream by heating or cooling it.

Another objective of the present invention to provide a lightweight and compact vane type as separator to provide improved collection of solid and liquid particulate while delivering an air/gas stream with zero-carryover of particulate or liquid and also having the ability to dehumidify the air or gas down to a percentage of desirable humidity, while minimizing air/gas flow pressure drop.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a baffle and a G-shape tube assembly;

FIG. 2 shows a G-shaped tube of the present invention;

FIG. 3 shows a G-shaped tube of the present invention;

FIG. 4 is a top view of a gas purifier of the present invention with G-shaped tubes connected with a manifold to circulate hot fluids for air tempering without the top and bottom seal plates;

FIG. 5 is a top view of a gas purifier of the present invention with G-shaped tubes connected with a manifold to circulate hot fluids for air tempering without the top and bottom seal plates;

FIG. 6 is a perspective view of a gas purifier of the present invention with G-shaped tubes connected with a manifold to circulate hot fluids for air tempering without the top and bottom seal plates; and

FIG. 7 is a perspective view of a gas purifier of the present invention with G-shaped tubes connected with a manifold to circulate hot fluids for air tempering without the top and bottom seal plates.

### DETAILED DESCRIPTION OF PREFERRED EMBODIMENTS:

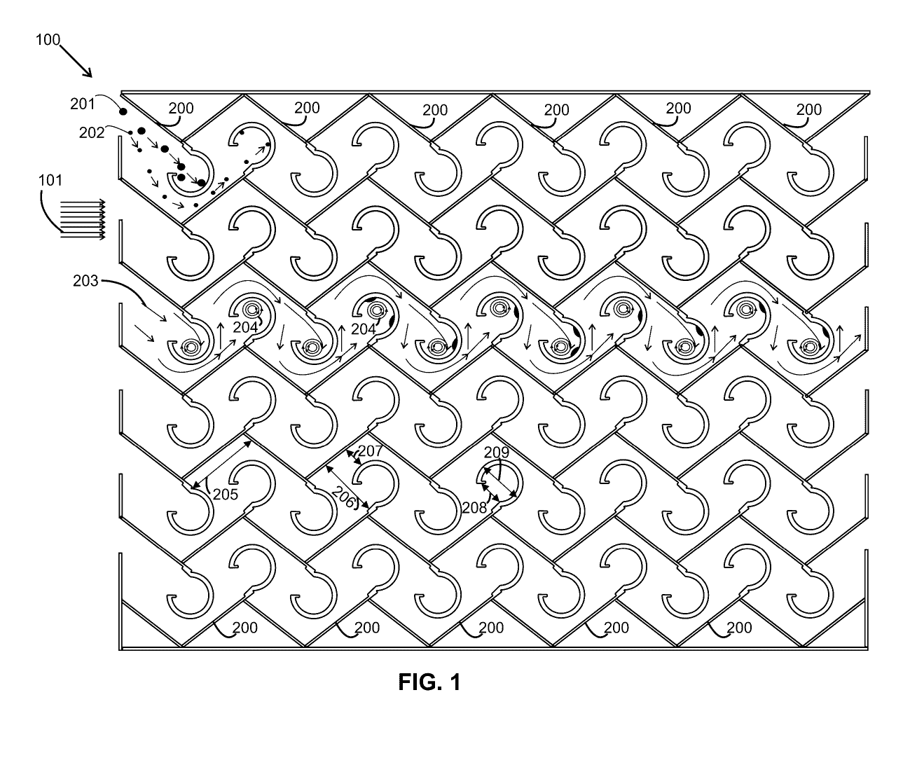

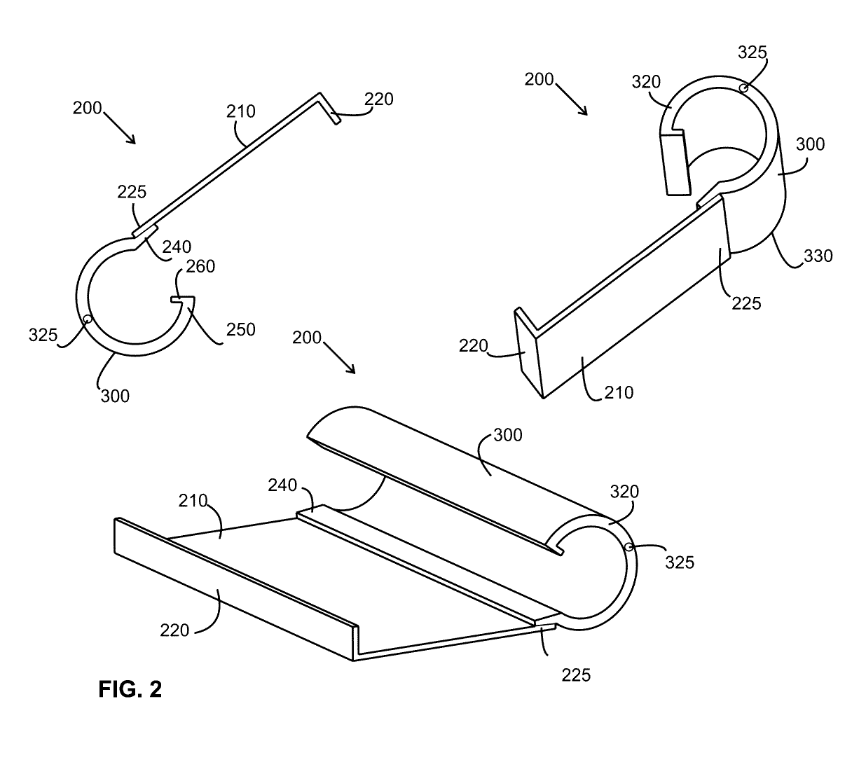

A preferred embodiment of the present particle separator is formed by attaching a series of especially designed vane-baffle elements 200 in a zig-zag configuration as shown in FIG. 1. One such vane-baffle element 200 is shown in FIG. 2. Each element 200 comprises of a planar vane sheet 210 (preferably made of sheet metal or any other shape retaining material). The vane sheet is bent on its first end 220 forming an L-shape cross section 220. This small bend is provided to weld two vanes 200 to each other forming the zig-zag vane configuration. The angle of the zig-zag vanes can be changed by the bent angle of the sheet. If the bent angle is 90 degrees, a 90 degree zig-zag partition is formed. The bend angle can be between 70 to 120 degrees, preferably 90 degrees for efficient particle separation.

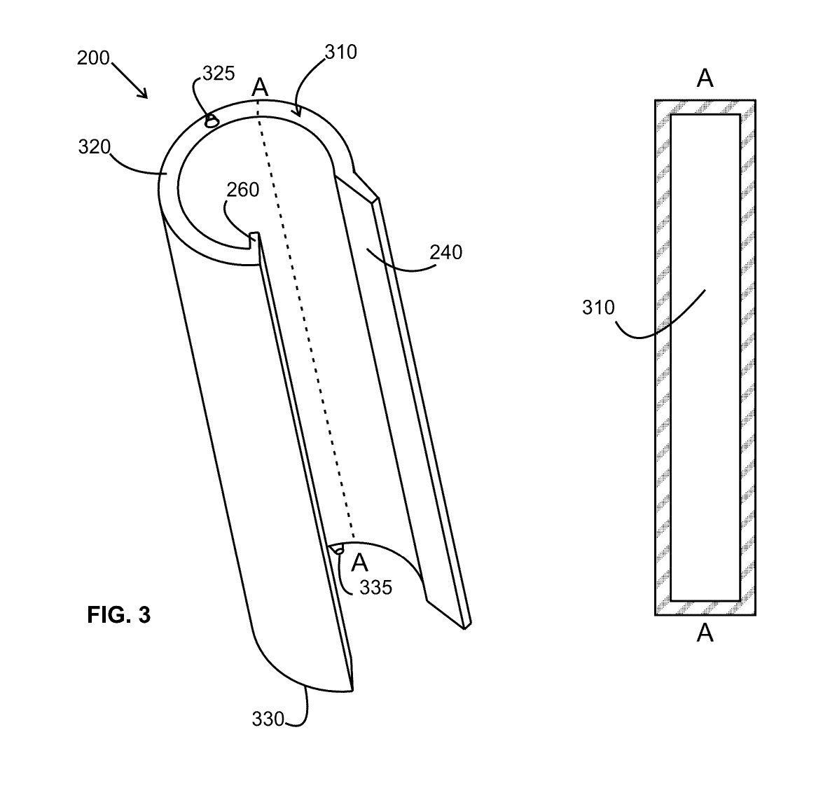

A G-shaped annular tube 300 is attached to the second of each vane 200. The G-shaped annular tube 300 has an inner annular channel 310 for fluid flow as shown in FIG. 3, having an outer diameter 209 and inlet opening 208. The top 320 and the bottom 330 of the tube 300 are closed and only an inlet port 325 is provided on the top surface 320 of the tube and an outlet port 335 is provided at the bottom 330 surface of the tube 300.

The first edge 240 of the annular tube 300 is attached (preferably welded) to the second end 225 of the sheet 210. A small baffle 260 is attached to the second edge 250 of the tube 300.

A plurality of vane-baffle elements are attached to each other to form a zig-zag partition with G-shaped gas pockets extending outwardly. In order to form the partition, the bend side of each vane 220 is attached to the back side of another element at the baffle end 225, forming a zig-zag with width 205 and 206. By repeatedly connecting these elements a zig-zag partition is formed. The tubular baffle diameter 209 blocks a large proportion of the flow path 206, leaving a smaller portion 207 for the flow that is not trapped inside the baffle to go through. The causes acceleration of the un-trapped flow in that region, forcing small particles towards the walls of the partition.

The length of the partition is determined based on the quality of the gas stream and the purification factor that is desired to reach. For a stream that has a very high particle or droplet content, a longer partition with more baffles are needed. Similarly, if the gas stream has very small particles, a longer partition and more baffles are needed to progressively separate the small particles.

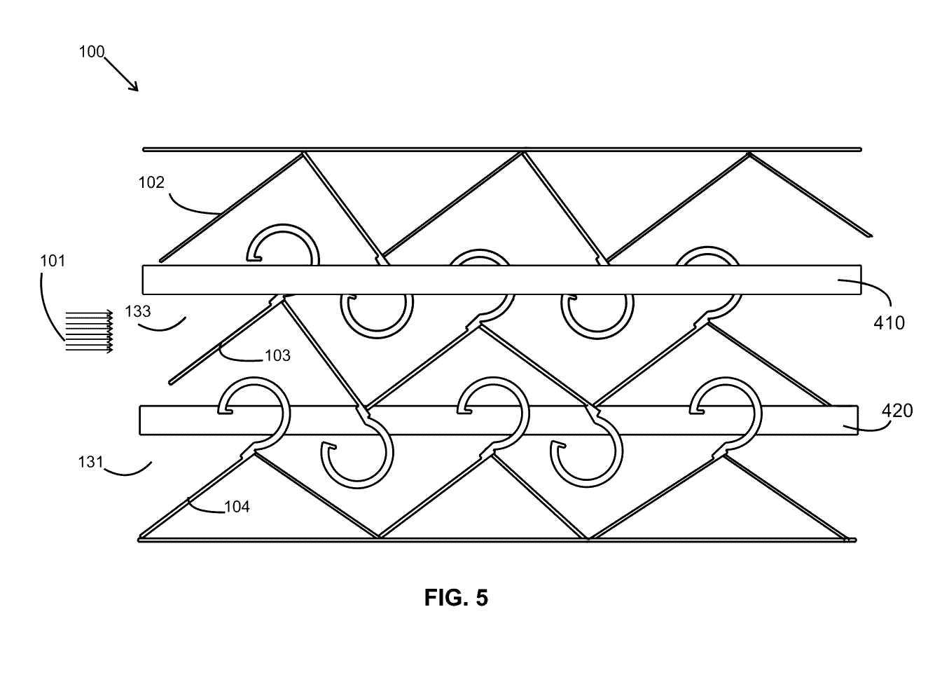

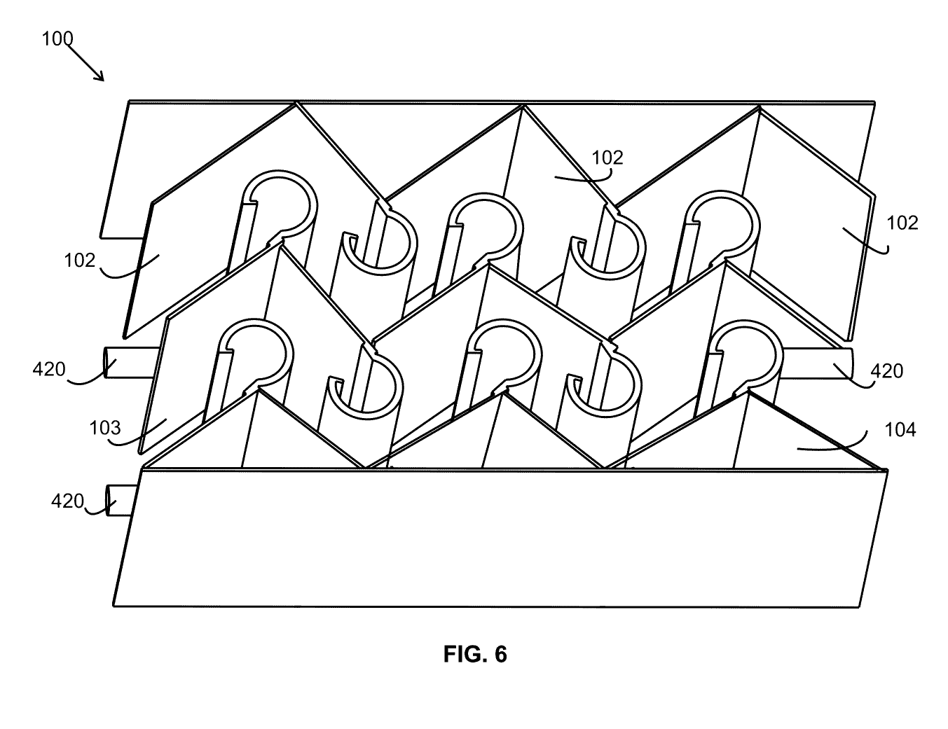

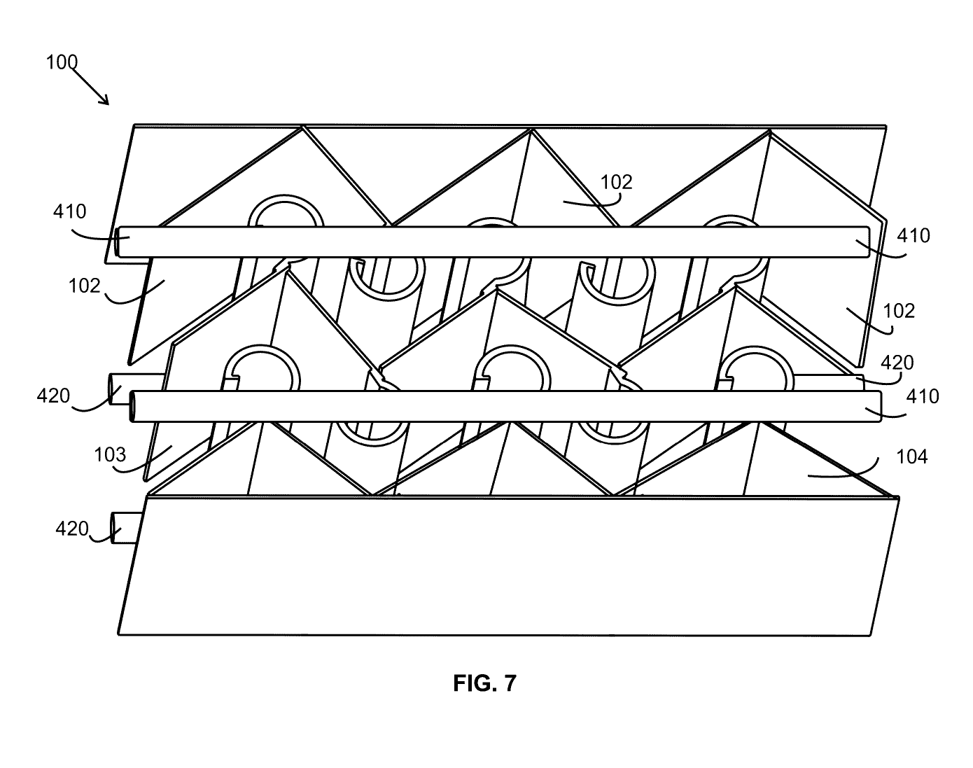

A gas purifier 100 for removing solid and liquid particles and to control humidity and volatiles in a gas stream 101 is shown in FIGS. 1-7. The gas purifier 100 comprises of a plurality of zig-zag vanes or plates, which are oriented vertically and are aligned parallel with each other 102-106. The zig-zag vanes are distributed at even intervals within an enclosure. Every two neighboring zig-zag vanes for a gas pathway 131-134. The zig-zag vanes are aligned to force a gas stream to follow a tortuous path between them going through plurality of turns and bends. The G-shaped annular tube 300 extends outwardly from the vertex of each of said zig-zag vanes. Each G-shaped tube having a first end, a second end, a top and a bottom, wherein the first end is attached to a zig-zag vane. The G-shaped gas pockets restrict the flow area, accelerating the flow through a narrow throat area. Only very small particles can deviate their path and flow passing the G-pocket. The G-pocket of the present device can trap particles as small as 0.5 microns. The G-shaped tubes are vertically oriented. Therefore, the trapped solid or liquid particles flow downward in the direction of the gravity to the bottom of the tubes, and collected in a collected tray.

In the preferred system, the diameter of said tube is equal to the half of the spacing between two zig-zag vanes.

Said top 310 having a fluid inlet port 325 and said bottom 330 having a fluid outlet port 335; a fluid inlet line 410 connected to the fluid inlet port 325 of each said G-shaped annular tube 300; a fluid outlet line 420 connected to the fluid outlet port 335 of said G-shaped annular tube 300.

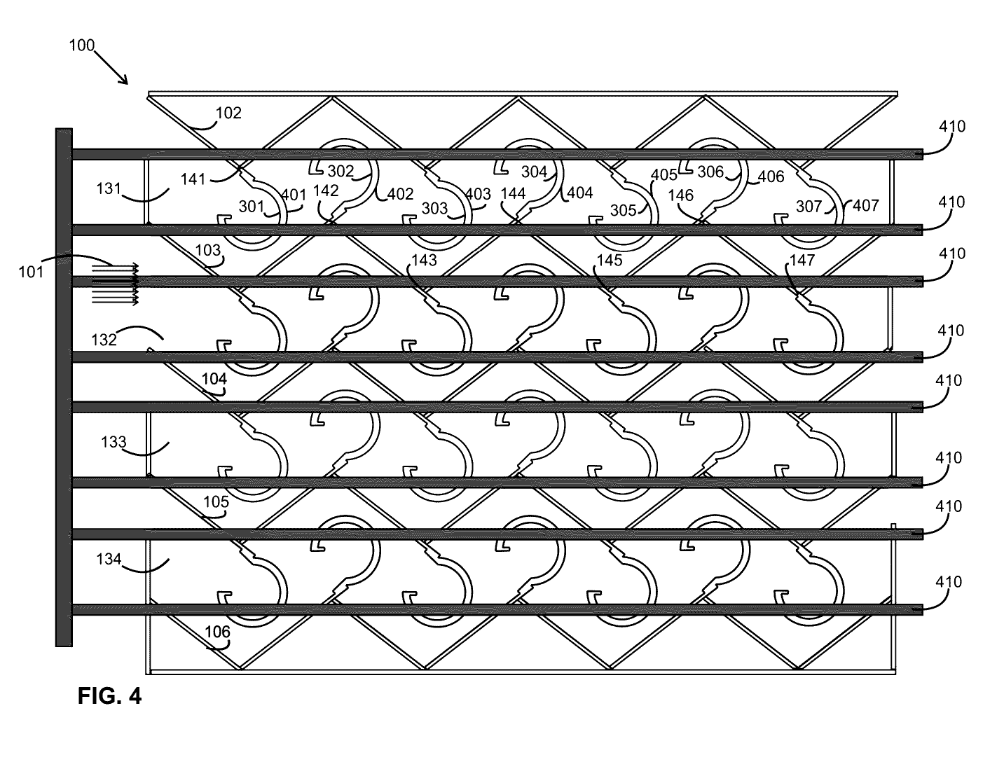

As shown in FIG. 4, the inlet port 325 of each vane 200 is attached to an inlet manifold 410 and the outlet port 335 of each vane 200 is connected to an outlet manifold 420. The inlet and outlet manifolds also act as an external support for the vanes and for stabilizing the Z-Z deflectors. They also keep the partitions at desired distances from each other. The inlet manifold 410 provides the inlet fluid to the vanes 200 and the outlet manifold 420 collect the fluid from the vanes 200, thereby providing for a fluid circulation inside the vanes 200. This system can be used to control the temperature of the gas stream.

One method of manufacturing the annular G-shaped tube 300 is by pressing and deforming of a rounded Stainless (thin) wall tube (O) with a desirable diameter. Such a tube can be pushed from one side to form a U-shaped annular tube. Then the top and the bottom end of the U-shaped annular tube are pressed. Then the edges of the U-shaped tube are further bend to form a G-shaped annular tube.

The particle and drop inertia and the airflow drag control the particle motion through zigzag passages. The separation efficiency is dependent on the airflow turning that could centrifuge drops out of the stream. The G-shaped tubes block a substantial portion of the gas passage way. Therefore, the gaseous flow has to deflect and pass through the remainder part of the passage way. This results in the flow acceleration, which will carry only minute particles. The rest of the particles enter the G-shaped tube. The flow entering the G-shaped tube has to go through a complete circulation 204. This circulation results in a centrifugal force acting on the particles, which forces the particles on the surfaces of the G-tube. Since the gas is continuously flowing towards the G-tube, the gas and particle flow trapped inside the tube may go through circulations, enhancing the particle removal. The opening of the gas passageway 207 for the flow coming towards the baffle is almost half of the width of the unobstructed passageway. The unique feature of the present device is that the baffles extend outwardly into the passageway, therefore the flow after passing through the first part of the zig-zag still has a small area to go through, keeping the flow close to the outer walls of the partition. Therefore, forcing the particles into the next baffle. This device can eliminate very small particles by recirculating the flow. Since the tubes are extended vertically, the trapped particles of solid or liquid collect on the inner walls of the tubes and flow downwards under the force of gravity.

The elements of this device can be made of different materials, including PVC, ABS, and other materials that can retain its form.

The new Thermal Centrifugal Vane Type Separator Baffle (TCVTSB) design is designed to remove volatile matter and humidity from the gas stream as well. The volatile matter is removed by trapping and saturating them inside the G-tube. As the concentration of the volatile matter in the G-tube increases, it will eventually saturate and form condensates of the volatile matter. The condensation process can be controlled by changing the temperature of the gas inside the G tube as well. Since the G tube is annular and has a temperature controlled fluid flowing inside it, the volatile matter can be condensed.

Experimental tests performed on an assemble air purifier of the present invention has shown the following results: The airflow inside the entrance is lower energetic than in the exit; the airflow inside the G-shaped baffle is lower energetic than inside the zigzag deflectors; the airflow in the first zigzag deflectors are lower energetic than in the last zigzag deflectors; the airflow inside the G-shaped baffle is most energetic in its interior area than in its entrance area, and it is most energetic in the last baffle than in the first first; and the airflow is more energetic for an inlet air velocity of 0.7 m/s, than for inlet air velocity of 1.546 m/s.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A gas purifier for removing solid and liquid particles and to control humidity and volatile concentration in a gas stream, comprising:
a. a plurality of vane-baffle elements, each element comprising:
i. a substantially rectangular planar vane having a vane-front, a vane-back, a first-vane end and a second-vane end, where the first-vane-end is bent in the direction of the vane-front at a predefined vane-angle forming a substantially L-shaped cross section;
ii. a tubular baffle having a G-shaped cross section, wherein said tubular baffle is partially open along its length and has a first-longitudinal end, a second-longitudinal end, a top and a bottom, and wherein the second-longitudinal end is bent at a predefined baffle-angle;
iii. said first-longitudinal end of said baffle is attached to the vane-front at the second-vane end, forming a vane-baffle element;
b. each said tubular baffle is annular allowing a secondary fluid to flow through it, and wherein each said baffle has an inlet port on its said top and an outlet port on its said bottom;
c. a plurality of zig-zag shaped baffled partitioned, each partition formed by attaching the bent side of a first vane-baffle element to the vane-back of a second vane-baffle element at the second-vane end, and continuing the attachment until a predefined partition length is obtained;
d. a plurality of gas-stream passage ways formed by vertically aligning said plurality of zig-zag partitions at a predefined partition spacing;
e. an enclosure to enclose said partitions, having an inlet to allow the gas stream into said gas passage ways and an outlet to discharge a purified gas stream;
f. a plurality of inlet manifolds connected to said inlet ports to distribute the secondary fluid into each of said annular baffles, whereby the inlet temperature of said secondary fluid is controlled to control the temperature of the gas stream; and
g. a plurality of outlet manifolds connected to said outlet ports to collect the secondary fluid from each of said annular baffles,
whereby each said tubular baffle extends outwardly into the gas passageway forcing particles, drops or vapor that are not captured inside the baffle to go through a circular motion and towards the entrance of a downstream baffle, thereby progressively capturing smaller and smaller materials.

2. The gas purifier of claim 1, wherein said predefined vane-angle is between 70° to 120° and preferably 90°.

3. The gas purifier of claim 1, wherein said predefined baffle-angle is 90°.

4. The gas purifier of claim 1, wherein said planar vane has a vane-length and a vane-width, and wherein said tubular baffle has a baffle-outer-diameter, and wherein said baffle diameter is half of said vane-width, whereby the tubular baffle obstructs substantially half of the opening in the gas passageways of the zig-zag partitions for both a flow coming towards the baffle and for the flow going away from the baffle.

5. The gas purifier of claim 1, wherein said partition spacing is 1.5 times of the vane-width.

6. The gas purifier of claim 1, wherein said vane-baffle elements are made of sheet metal.

7. The gas purifier of claim 6, wherein each said baffle is welded to said vane.

8. The gas purifier of claim 6, wherein said vane-baffle elements are welded to each other to form the partition.

9. The gas purifier of claim 1, wherein said vane-baffle elements are made of any form retaining material.

10. The gas purifier of claim 1, further having a collecting pan provided below said plurality of partitions to collect a separated solid and liquid flown downwardly from each said G-shaped tube.

11. A method of making a zig-zag gas purifier with baffles for removing solid and liquid particles and to control humidity and volatiles in a gas stream, the method comprising steps of:
a. constructing a vane-baffle element by steps of:
i. preparing a substantially rectangular planar vane having a vane-front, a vane-back, a first-vane end and a second-vane end;
ii. bending the first-vane-end in the direction of the vane-front at a predefined vane-angle forming a substantially L-shaped cross section;
iii. constructing a tubular baffle having a G-shaped cross section, wherein said tubular baffle is partially open along its length and has a first-longitudinal end, a second-longitudinal end, a top and a bottom;
iv. bending the second longitudinal end at a predefined baffle-angle;
v. attaching said first-longitudinal end of said baffle to the vane-front at the second-vane end, to form a vane-baffle element;
b. attaching the bent side of a first vane-baffle element to the vane-back of a second vane-baffle element at the second-vane end;
c. repeating step b to form a zig-zag shaped baffled partition having a predefined partition length;
d. constructing an enclosure to install said zig-zag shaped partitions, and
e. vertically installing a plurality of said zig-zag shaped partitions at a predefined partition spacing inside said enclosure to form a plurality of gas-stream passage ways,
whereby each said tubular baffle extends outwardly into the gas passageway and forcing any particle, drop or vapor that is not captured inside the baffle to go through a circular motion and towards the entrance of a downstream baffle, thereby progressively capturing smaller and smaller materials.

12. A method of constructing an annular G-shaped baffle, comprising of steps of:
a. obtaining a tube made of a rigid but deformable material having a length, an outer diameter, and a wall thickness;
b. pressing said tube along its length using a rod with a diameter which is smaller than the tube outer diameter to form a substantially annular tube having a U shaped cross section;
c. pressing or welding to close the top and the bottom openings of the tube;
d. making an inlet port at the closed top and an outlet port at the closed bottom; and
e. pressing the sides of the U shaped tube to form a G-shaped tube.
